(19) United States
(12) Patent Application Publication
(10) Pub. No.: US 2005/0015243 A1
(43) Pub. Date: Jan. 20, 2005

(54) Apparatus and method for converting pitch delay using linear prediction in speech transcoding

(76) Inventors: Eung Don Lee, Daejeon-city (KR); Hyun Woo Kim, Seoul (KR); Do Young Kim, Daejeon-city (KR); Chang Dong Yoo, Daejeon-city (KR); Seong Ho Seo, Daegu-city (KR); Dal Won Jang, Kyungsangnam-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,779

(22) Filed: Dec. 30, 2003

(30) Foreign Application Priority Data
Jul. 15, 2003 (KR) 2003-48424

(51) Int. Cl. G10L 19/04

(52) U.S. Cl. 704/219

(57) ABSTRACT

Provided are an apparatus and method for converting a pitch delay using linear prediction in speech transcoding. A linear interpolating portion linearly interpolates a closed-loop pitch delay decoded by a selected mode vocoder (SMV) speech decoder to make the closed-loop pitch delay fit in a search section for open-loop pitch delays of G.723.1 speech encoder, to obtain a changed closed-loop pitch delay of the SMV decoder. A predicted value calculating portion calculates a predicted pitch delay using linear prediction, based on past closed-loop pitch delays of the G.723.1 speech encoder. A difference calculating portion calculates a difference between the changed closed-loop pitch delay of the SMV speech decoder and the calculated predicted pitch delay. When the calculated difference is less than the predetermined threshold value, a pitch delay determining portion determines the changed closed-loop pitch delay of the SMV speech decoder to be an open-loop pitch delay of the G.723.1 speech encoder. A pitch delay detecting portion detects a closed-loop pitch delay of the G.723.1 speech encoder using a conventional method, based on the determined open-loop pitch delay of the G.723.1 speech encoder.

### CROSS-REFERENCE TO RELATED APPLICATION

This application claims the priority of Korean Patent Application No. 2003-48424, filed on Jul. 15, 2003, in the Korean Intellectual Property Office, the disclosure of which is incorporated herein in its entirety by reference.

### BACKGROUND OF THE INVENTION

1. Field of the Invention

The present invention relates to the field of vocal communication, and more particularly, to an apparatus and method for transcoding speech, in which a pitch delay is converted using linear prediction in transcoding between a bit stream encoded by a selected mode vocoder (SMV) speech encoder and another bit stream encoded by a G.723.1 speech encoder.

2. Description of the Related Art

Speech transcoding involves converting a bit stream encoded by an encoder into another bit stream suitable for use in a different encoder. At present, there are various standards for speech coding, and each communication technology adopts its own speech coding standards. For example, Voice over Intent Protocol (VoIP) adopts as speech coding standards G.732.1, G.729, and G.729A of the International Telecommunication Union Telecommunication standardization sector (ITU-T), and Global System for Mobile communications (GSM) adopts Enhanced Full Rate (EFR) speech coding of the 3^{rd}-Generation Partnership Projects (3GPP/3GPP2). Also, Wideband Code Division Multiple Access (W-CDMA) adopts or plans to adopt as speech coding standards Adaptive Multi Rate (AMR) speech coding of the 3GPP, Personal Communication System (PCS) adopts or plans to adopt Enhanced Variable Rate Coders (EVRC) of the 3GPP2, and IMT2000 adopts or plans to adopt SMV of the 3GPP2. However, since each of these speech coding standards is used after being standardized into another standard suitable for use in a different communication network, speech coders complying with different coding standards perform speech coding in different manners. Accordingly, when different communication networks are connected, there is a need for transcoding that can convert a bit stream that has been encoded by a speech encoder used in any of the communication networks.

In pitch delay conversion methods in speech transcoding that have been developed so far, an original pitch delay of a front speech encoder is used as a pitch delay of a rear speech encoder, and a maximum pitch delay of the front speech encoder is used as the pitch delay of the rear speech encoder when the original pitch delay of the front encoder falls outside an acceptable scope for the rear speech encoder. Also, when a difference between the pitch delays of the front and rear speech encoders is large, a pitch smoothing technique is used.

### SUMMARY OF THE INVENTION

The present invention provides an apparatus and method for converting a pitch delay using linear prediction in speech transcoding, by which degradation in speech quality due to pitch delays that are calculated in different manners is prevented.

According to an aspect of the present invention, there is provided an apparatus for converting a pitch delay using linear prediction in speech transcoding, the apparatus comprising: a linear interpolating portion, which linearly interpolates a closed-loop pitch delay decoded by a selected mode vocoder (SMV) speech decoder to make the closed-loop pitch delay fit in a search section for open-loop pitch delays of G.723.1 speech encoder, to thereby obtain a changed closed-loop pitch delay of the SMV decoder; a predicted value calculating portion, which calculates a predicted pitch delay using linear prediction, based on past closed-loop pitch delays of the G.723.1 speech encoder; a difference calculating portion, which calculates a difference between the changed closed-loop pitch delay of the SMV speech decoder and the calculated predicted pitch delay; a comparing portion, which compares the calculated difference with a predetermined threshold value and outputs the result of the comparison; a pitch delay determining portion, which, when the calculated difference is less than the predetermined threshold value, determines the changed closed-loop pitch delay of the SMV speech decoder to be an open-loop pitch delay of the G.723.1 speech encoder; and a pitch delay detecting portion, which detects a closed-loop pitch delay of the G.723.1 speech encoder using a conventional method of detecting a closed-loop pitch delay of the G.723.1 speech encoder, based on the determined open-loop pitch delay of the G.723.1 speech encoder.

According to another aspect of the present invention, there is provided a method for converting a pitch delay using linear prediction in speech transcoding, the method comprising: (a) linearly interpolating a closed-loop pitch delay decoded by a selected mode vocoder (SMV) speech decoder to make the closed-loop pitch delay fit in a search section for open-loop pitch delays of G.723.1 speech encoder, and obtaining a changed closed-loop pitch delay of the SMV speech decoder; (b) calculating a predicted pitch delay using linear prediction, based on past closed-loop pitch delays of the G.723.1 speech encoder; (c) calculating a difference between the changed closed-loop pitch delay of the SMV decoder and the calculated predicted pitch delay; (d) comparing the calculated difference with a predetermined threshold value and outputting the result of the comparison; (e) determining the changed closed-loop pitch delay of the SMV speech decoder to be an open-loop pitch delay of the G.723.1 speech encoder when the calculated difference is less than the predetermined threshold value; and (f) detecting a closed-loop pitch delay of the G.723.1 speech encoder using a conventional method of detecting a closed-loop pitch delay of the G.723.1 speech encoder, based on the determined closed-loop pitch delay of the G.723.1 speech encoder.

Thus, it is possible to reduce the amount of computation required for the detection of the open-loop pitch delay of the G.723.1 speech encoder, and to prevent degradation in speech quality due to an inaccurate closed-loop pitch delay of the SMV speech encoder.

### BRIEF DESCRIPTION OF THE DRAWINGS

The above and other aspects and advantages of the present invention will become more apparent by describing in detail an exemplary embodiment thereof with reference to the attached drawings in which:

FIG. 1 is a block diagram of an apparatus for converting a pitch delay using linear prediction in speech transcoding, according to an embodiment of the present invention; and

FIG. 2 is a flowchart describing a method for converting a pitch delay using linear prediction in speech transcoding, according to an embodiment of the present invention.

### DETAILED DESCRIPTION OF THE INVENTION

The present invention will now be described more fully with reference to the accompanying drawings, in which a preferred embodiment of the invention is shown. Throughout the drawings, like reference numerals are used to refer to like elements.

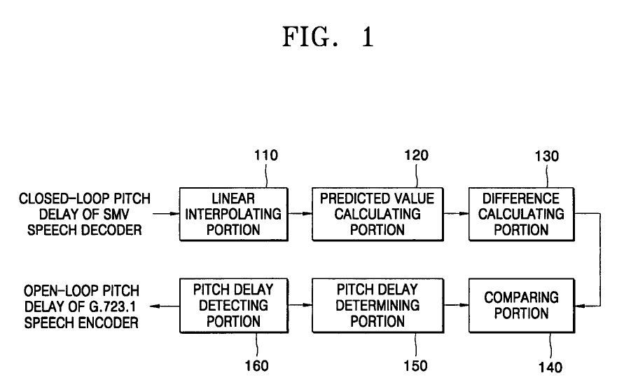

FIG. 1 is a block diagram of an apparatus for converting a pitch delay using linear prediction in speech transcoding, according to an embodiment of the present invention. Hereinafter, it is assumed that speech transcoding is performed from an SMV speech encoder to a G.723.1 speech encoder.

Referring to FIG. 1, the apparatus for converting a pitch delay using linear prediction in speech transcoding according to the present invention includes a linear interpolating portion 110, a predicted value calculating portion 120, a difference calculating portion 130, a comparing portion 140, a pitch delay determining portion 150, and a pitch delay detecting portion 160.

The linear interpolating portion 110 linearly interpolates a closed-loop pitch delay decoded by an SMV speech decoder to make the closed-loop pitch delay fit in a search section for open-loop pitch delays of G.723.1 speech encoder. This linear interpolation is required because the frame sizes of the SMV speech decoder and the G.723.1 speech encoder are different from each other, the numbers of detected pitch delays of the SMV speech decoder and the G.723.1 speech encoder are different from each other, and a search section for closed-loop pitch delays of the SMV speech decoder and a search section for open-loop pitch delays of the G.723.1 speech encoder are not identical. In order to make the sections in which pitch delays are detected and the numbers of detected pitch delays the same in the SMV speech decoder and the G.723.1 speech encoder, the linear interpolating portion 110 extracts, through linear interpolation, two pitch delays of the SMV speech decoder every 30 ms, which corresponds to a frame of the G.723.1 speech encoder.

The predicted value calculating portion 120 calculates a predicted pitch delay using linear prediction, based on past open-loop pitch delays of the G.723.1 speech encoder. The predicted value calculating portion 120 performs linear prediction on open-loop pitch delays of the G.723.1 speech encoder that are determined in the past speech frame through pitch delay conversion, thus predicting a reference pitch delay in a current speech frame.

The difference calculating portion 130 calculates a difference between the closed-loop pitch delay of the SMV speech decoder that is linearly interpolated by the linear interpolating portion 110, and the reference pitch delay that is predicted by the predicted value calculating portion 120. The comparing portion 140 compares the difference calculated by the difference calculating portion 130 with a predetermined threshold value, and outputs the result of the comparison.

When the difference is less than the predetermined threshold value, the pitch delay determining portion 150 determines the closed-loop pitch delay of the SMV speech encoder that is obtained through linear interpolation to be an open-loop pitch delay of the G.723.1 speech encoder. When the difference is equal to or more than the predetermined threshold value, the pitch delay determining portion 150 determines the pitch delay obtained using a conventional method of detecting an open-loop pitch delay of the G.723.1 speech encoder to be the open-loop pitch delay of the G.723.1 speech encoder. Since speech quality is degraded when the difference is more than the predetermined threshold, the closed-loop pitch delay of the SMV speech decoder that is obtained through linear interpolation is not used.

The pitch delay detecting portion 160 detects a closed-loop pitch delay of the G.723.1 speech encoder using a conventional method, based on the determined open-loop pitch delay of the G.723.1 speech encoder.

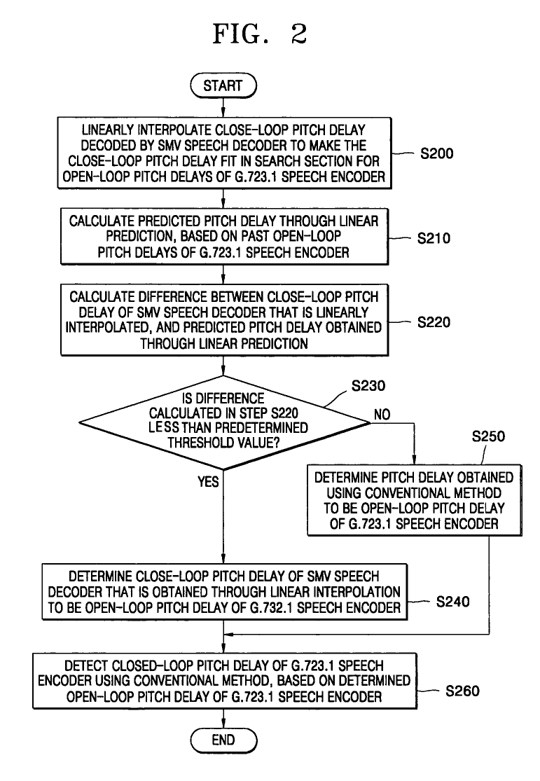

FIG. 2 is a flowchart describing a method for converting a pitch delay using linear prediction in speech transcoding, according to the present invention. Referring to FIG. 2, in the first step S200, the linear interpolating portion 110 linearly interpolates the closed-loop pitch delay decoded by the SMV speech decoder to make the closed-loop pitch delay fit in a search section for open-loop pitch delays of G.723.1 speech encoder. In step S210, the predicted value calculating portion 120 calculates a predicted pitch delay through linear prediction, based on the past open-loop pitch delays of the G.723.1 speech encoder. In step S220, the difference calculating portion 130 calculates the difference between the closed-loop pitch delay of the SMV speech decoder that is linearly interpolated and the predicted pitch delay obtained through linear prediction. In step S230, the comparing portion 140 compares the difference calculated in step S220 with the predetermined threshold value. In step S240, when the difference calculated in step S220 is less than the predetermined threshold value, the pitch delay determining portion 150 determines the closed-loop pitch delay of the SMV speech decoder that is obtained through linear interpolation to be the open-loop pitch delay of the G.723.1 speech encoder. In step S250, when the difference calculated in step S220 is equal to or more than the predetermined threshold value, the pitch delay determining portion 150 determines the pitch delay obtained using the conventional method of detecting an open-loop pitch delay of the G.723.1 speech encoder to be the open-loop pitch delay of the G.723.1 speech encoder. In step S260, the pitch delay detecting portion 160 detects the closed-loop pitch delay of the G.723.1 speech encoder using the conventional method, based on the determined open-loop pitch delay of the G.723.1 speech encoder.

The apparatus and method for converting a pitch delay using linear prediction in speech transcoding according to the present invention can reduce the amount of computation required for the detection of the open-loop pitch delay of the G.723.1 speech encoder, by using the closed-loop pitch delay of the SMV speech decoder as the open-loop pitch delay of the G.723.1 speech encoder. Also, by detecting an inaccurate closed-loop pitch delay of the SMV speech decoder through linear prediction, and determining a new open-loop pitch delay of the G.723.1 speech encoder to be the open-loop pitch delay of the G.723.1 speech encoder using the conventional method, it is possible to prevent degradation in speech quality due to the inaccurate closed-loop pitch delay of the SMV speech decoder. Furthermore, the apparatus and method for converting a pitch delay using linear prediction in speech transcoding according to the present invention can be extensively applied to transcoding between various speech encoders that detect pitch delays.

The present invention may be embodied as a computer readable code stored on a computer readable medium. The computer readable medium includes all kinds of recording devices in which computer readable data are stored. For example, the computer readable medium includes, but is not limited to, ROMs, RAMs, CD-ROMs, magnetic tapes, floppy disks, optical data storage devices, and carrier waves such as those employed in transmission over the Internet. In addition, the computer readable medium may be distributed throughout computer systems connected via a network, and the present invention, embodied as a computer readable code, may be stored on that distributed computer readable medium and executed therefrom.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

1. An apparatus for converting a pitch delay using linear prediction in speech transcoding, the apparatus comprising:
a linear interpolating portion, which linearly interpolates a closed-loop pitch delay decoded by a selected mode vocoder (SMV) speech decoder to make the closed-loop pitch delay fit in a search section for open-loop pitch delays of G.723.1 speech encoder, to thereby obtain a changed closed-loop pitch delay of the SMV decoder;
a predicted value calculating portion, which calculates a predicted pitch delay using linear prediction, based on past closed-loop pitch delays of the G.723.1 speech encoder;
a difference calculating portion, which calculates a difference between the changed closed-loop pitch delay of the SMV speech decoder and the calculated predicted pitch delay;
a comparing portion, which compares the calculated difference with a predetermined threshold value and outputs the result of the comparison;
a pitch delay determining portion, which, when the calculated difference is less than the predetermined threshold value, determines the changed closed-loop pitch delay of the SMV speech decoder to be an open-loop pitch delay of the G.723.1 speech encoder; and
a pitch delay detecting portion, which detects a closed-loop pitch delay of the G.723.1 speech encoder using a conventional method of detecting a closed-loop pitch delay of the G.723.1 speech encoder, based on the determined open-loop pitch delay of the G.723.1 speech encoder.

2. The apparatus of claim 1, wherein the linear interpolating portion extracts two pitch delays of the SMV decoder every 30 ms, which corresponds to a frame of the G.723.1 speech encoder, and linearly interpolates the extracted pitch delays of the SMV decoder to obtain the changed closed-loop pitch delay of the SMV speech decoder.

3. The apparatus of claim 1, wherein when the calculated difference is equal to or more than the predetermined threshold value, the pitch delay determining portion determines the closed-loop pitch delay of the G.723.1 speech encoder that is obtained using a conventional method of detecting a open-loop pitch delay of the G.723.1 speech encoder to be the open-loop pitch delay of the G.723.1 speech encoder.

4. A method for converting a pitch delay using linear prediction in speech transcoding, the method comprising:
(a) linearly interpolating a closed-loop pitch delay decoded by a selected mode vocoder (SMV) speech decoder to make the closed-loop pitch delay fit in a search section for open-loop pitch delays of G.723.1 speech encoder, and obtaining a changed closed-loop pitch delay of the SMV speech decoder;
(b) calculating a predicted pitch delay using linear prediction, based on past closed-loop pitch delays of the G.723.1 speech encoder;
(c) calculating a difference between the changed closed-loop pitch delay of the SMV decoder and the calculated predicted pitch delay;
(d) comparing the calculated difference with a predetermined threshold value and outputting the result of the comparison;
(e) determining the changed closed-loop pitch delay of the SMV speech decoder to be an open-loop pitch delay of the G.723.1 speech encoder when the calculated difference is less than the predetermined threshold value; and
(f) detecting a closed-loop pitch delay of the G.723.1 speech encoder using a conventional method of detecting a closed-loop pitch delay of the G.723.1 speech encoder, based on the determined closed-loop pitch delay of the G.723.1 speech encoder.

5. The method of claim 4, wherein step (a) comprises:
(a1) extracting two pitch delays of the SMV decoder every 30 ms, which corresponds to a frame of the G.723.1 speech encoder;
(a2) linearly interpolating the extracted pitch delays of the SMV decoder to obtain the changed closed-loop pitch delay of the SMV speech decoder.

6. The method of claim 4, wherein in step (e), when the calculated difference is equal to or more than the predetermined threshold value, the closed-loop pitch delay of the G.723.1 speech encoder that is obtained using the conventional method is determined to be the open-loop pitch delay of the G.723.1 speech encoder.
